(19) United States
(12) Patent Application Publication
(10) Pub. No.: US 2016/0144750 A1
(43) Pub. Date: May 26, 2016

(54) VEHICLE SEAT WITH A LOCKING UNIT

(71) Applicant: JOHNSON CONTROLS GMBH, Burscheid (DE)

(72) Inventors: Patrick HANDL, Köln (DE); Andreas VEDDER, Haan (DE); Igor GORDEENKO, Frechen (DE); Uwe MOELLER, Solingen (DE); Oezkan DEMIRCI, Bochum (DE); Dennis POHLSCHEIDT, Troisdorf (DE); Martin CHRISTALL, Solingen (DE)

(73) Assignee: Johnson Controls GMBH, Burscheid (DE)

(21) Appl. No.: 14/899,357

(22) PCT Filed: Jun. 13, 2014
(86) PCT No.: PCT/EP2014/062307

§ 371 Date: Dec. 17, 2015

(30) Foreign Application Priority Data
Jun. 18, 2013 (DE) 10 2013 211 332.3

(51) Int. Cl. B60N 2/22; B60N 2/20

(52) U.S. Cl. CPC B60N 2/2245; B60N 2/206

(57) ABSTRACT

A vehicle seat (1) includes a structural part (3) which has a lock connecting plate (60), and a locking unit (10) secured to the lock connecting plate (60). The locking unit (10) includes at least one bearing bolt (51, 52) having a through opening (55) through which a securing device (65) passes. The at least one bearing bolt (51, 52) projects through a securing opening (61) of the lock connecting plate (60).

### CROSS REFERENCE TO RELATED APPLICATIONS

This application is a United States National Phase Application of International Application PCT/EP2014/062307 filed Jun. 13, 2014 and claims the benefit of priority under 35 U.S.C. §119 of German Patent Application 10 2013 211 332.3 filed Jun. 18, 2013 the entire contents of which are incorporated herein by reference.

### FIELD OF THE INVENTION

The invention relates to a vehicle seat having a locking unit which is secured to the lock connection sheet, wherein the locking unit has at least one bearing pin having a through-opening through which a securing means protrudes,

### BACKGROUND OF THE INVENTION

DE 10 2008 051 832 A1 discloses a locking unit for a vehicle seat. Such a locking unit comprises a pivotably supported rotary latch for locking with a pin. A catch detent which is pivotably supported about another pivot axle secures the rotary latch in the locked state. A clamping element which is referred to as a tolerance compensation detent applies a closing torque to the rotary latch and in this manner eliminates a play which is provided between the rotary latch and the pin.

DE 20 2011 100 040 U1 also discloses a locking unit for a vehicle seat. The rotary latch of this locking unit has a recess which deviates from the circular form and which is approximately in the form of an elongate hole and by means of which it is pivotably supported on a bush or a bearing pin.

Such locking units are used, for example, to lock a backrest of a vehicle seat to a seat member and/or to a bodywork or structure of a vehicle or to lock the vehicle seat to the bodywork or structure of the vehicle. Engine hoods, rear doors or doors of vehicles can also be locked to the bodywork or the structure of the vehicle using such locking units.

DE 10 2008 033 304 A1 discloses a generic vehicle seat having a locking unit. In this instance, the locking unit is secured to a structural component, in particular a backrest of the vehicle seat, and serves to lock the backrest to a structure of the vehicle or the bodywork thereof. To this end, the locking unit has a rotary latch which is referred to as a detent and which in the locked state of the locking unit engages around a locking pin which is secured to the structure of the vehicle.

The locking unit has two bearing pins which are used to pivotably support the rotary latch and two securing elements which are provided to secure the rotary latch in the locked state. The two bearing pins also serve to secure the locking unit to the structural component of the vehicle seat and are constructed in a substantially hollow-cylindrical manner. In order to secure the locking unit to the structural component of the vehicle seat, there are further provided two screws which each engage through one of the two bearing pins and are screwed into the structural component or an additional nut.

DE 103 08 678 A1 discloses a locking unit for motor vehicle rear seat backrests. This locking unit also has two hollow-cylindrical bearing pins. In order to secure the locking unit to the backrest structure, two screws which protrude through the bearing pins are provided.

### SUMMARY OF THE INVENTION

An object of the invention is to improve a vehicle seat having a locking unit of the type mentioned in the introduction, in particular to increase the strength and the stability of the connection between the structural component and the locking unit.

A vehicle seat of the generic type comprises a structural component, in particular a backrest, which has a lock connection sheet and a locking unit which is secured to the lock connection sheet, wherein the locking unit has at least one bearing pin having a through-opening through which a securing means protrudes.

According to the invention, there is provision for the at least one bearing pin to protrude into a securing opening of the lock connection sheet.

As a result of the fact that the at least one bearing pin protrudes into a securing opening of the lock connection sheet, the bearing pin and the lock connection sheet also absorb loads which act on the locking unit, in particular shearing stresses which occur in the event of a crash. Consequently, the load-bearing capacity of the connection between the structural component and the locking unit is increased. Furthermore, the assembly of the locking unit on the lock connection sheet is also simplified since the securing opening of the lock connection sheet constitutes a guide for the bearing pin.

Preferably, the bearing pin has a first axial portion having a first outer diameter and a second axial portion having a second outer diameter, wherein the second outer diameter is smaller than the first outer diameter. The second axial portion having the second outer diameter thus forms a step with respect to the first axial portion having the first outer diameter.

In this instance, the second axial portion advantageously protrudes into the securing opening of the lock connection sheet. The lock connection sheet is then positioned on the step formed by the second axial portion and is consequently fixed in an axial direction.

If the second outer diameter, at least substantially, corresponds to the inner diameter of the securing opening, the locking unit is secured to the lock connection sheet in a radial direction in a positive-locking manner, whereby the assembly is further simplified and the strength is increased.

According to an advantageous embodiment of the invention, the bearing pin has a third axial portion having a third outer diameter, wherein the third outer diameter is smaller than the first outer diameter. The third axial portion having the third outer diameter consequently forms another step with respect to the first axial portion having the first outer diameter.

Preferably, the first axial portion is arranged in an axial direction between the second axial portion and the third axial portion. The third axial portion can then protrude into a bearing hole of a side plate of the locking unit opposite the lock connection sheet. The side plate is then positioned on the step formed by the third axial portion and is consequently fixed in an axial direction.

When the inner diameters of the axial portions are identical, the production of the bearing pin is relatively simple.

Advantageously, the third axial portion protrudes into a bearing hole in a side plate of the locking unit facing away from the lock connection sheet.

The length of the third axial portion is preferably greater than the thickness of the side plate which faces away from the lock connection sheet so that the third axial portion protrudes through the side plate which faces away from the lock connection sheet.

In order to support the bearing pin, the locking unit advantageously has a side plate which is in abutment with the lock connection sheet and which comprises at least one bearing hole in which the first axial portion is inserted.

According to an advantageous development of the invention, there is arranged around the bearing hole a hollow cylinder which extends in the direction away from the lock connection sheet and which at least partially surrounds the first axial portion.

Preferably, the first axial portion has in a central region a flange-like expansion whose outer diameter is greater than the first outer diameter, wherein the end face of the hollow cylinder facing away from the lock connection sheet is in abutment with the flange-like expansion. The side plate is then fixed in an axial direction between the flange-like expansion and the lock connection sheet.

A spring which pretensions a rotary latch of the locking unit is placed around the hollow cylinder.

The securing means is preferably constructed as a screw which has a head and a shaft.

The shaft of the screw engages through the bearing pin and the lock connection sheet.

The invention is explained in greater detail below with reference to an advantageous embodiment which is illustrated in the Figures. However, the invention is not limited to this embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat;

FIG. 2 is an exploded illustration of a locking unit according to the state of the art;

FIG. 3 is a sectional view through a bearing pin of a locking unit according to the invention; and

FIG. 4 is the bearing pin of the locking unit according to FIG. 3 with a securing means.

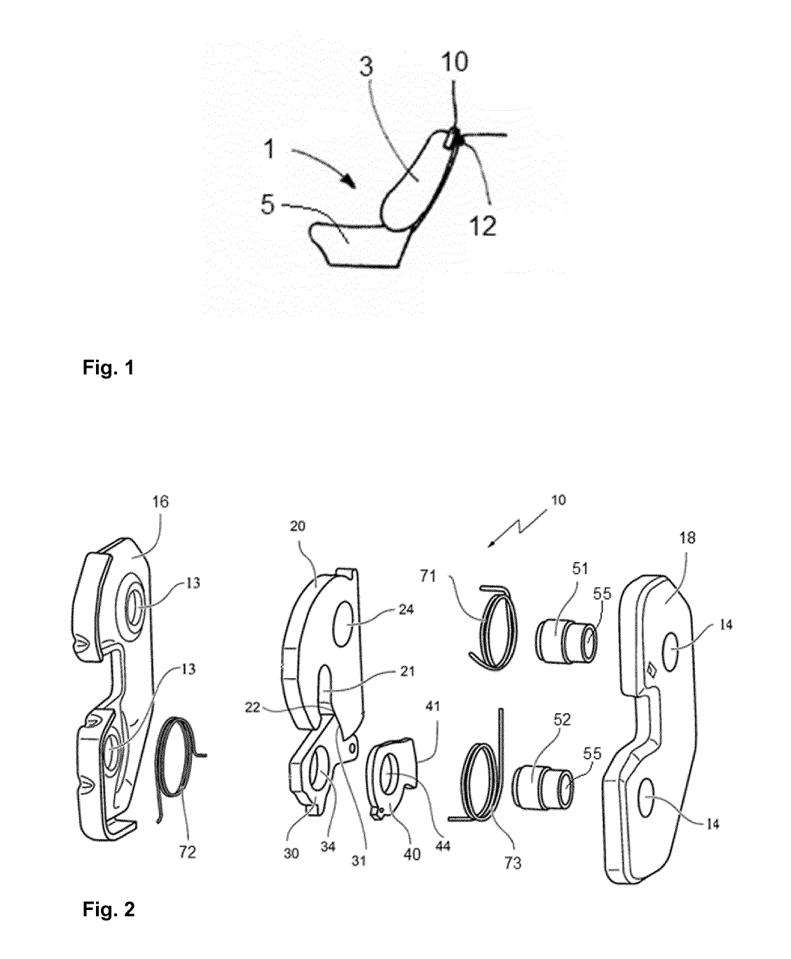

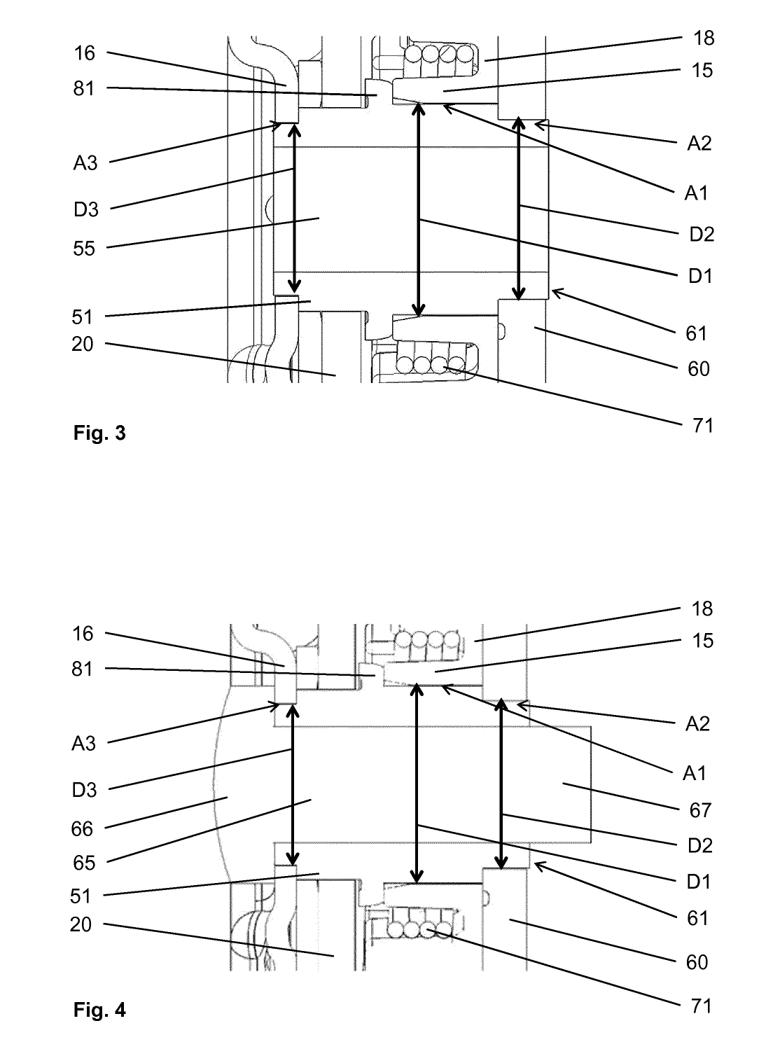

### DESCRIPTION OF THE PREFERRED EMBODIMENTS

In a motor vehicle, a locking unit 10 for connecting a structural component, in this instance a backrest 3, of a vehicle seat 1, in particular a rear seat, is provided on a vehicle structure. The backrest 3 is in this instance fitted to a seat component 5 so as to be able to be pivoted from a position for use into a position for non-use.

The locking unit 10 can also be used at other locations, for example, for securing the seat member 5 of the vehicle seat 1 to the base structure of the motor vehicle or in a door lock.

The arrangement of the vehicle seat 1 within the vehicle and the conventional travel direction thereof define the directional indications used below. In this instance, a direction which is orientated perpendicularly to the ground is referred to below as the vertical direction and a direction perpendicular to the vertical direction and perpendicular to the travel direction is referred to below as the transverse direction.

The locking unit 10 has a lock housing which comprises a first side plate 16 and a second side plate 18. The base faces of the side plates 16, 18 are in this instance constructed in a substantially flat manner and arranged in a plane defined by the travel direction and the vertical direction, that is to say, perpendicularly to the transverse direction.

The first side plate 16 comprises two first bearing holes 13 which are constructed in this instance in a circular manner and the second side plate 18 comprises two second bearing holes 14 which are constructed in this instance in a circular manner. There is arranged around the second bearing holes 14 a respective hollow cylinder 15 which extends in the direction toward the first side plate 16. The hollow cylinder 15 is in this instance constructed integrally with the second side plate 18 and constructed as a plunged collar. It is also conceivable to construct the hollow cylinder 15 as a separate sleeve.

The first side plate 16 and the second side plate 18 form a receiving member which opens in the direction of a locking pin 12 in order to receive it for locking. In this case, the locking unit 10 is secured to the backrest 3 and the locking pin 12 is secured to the vehicle structure. It is also conceivable for the locking unit 10 to be secured to the vehicle structure and the locking pin 12 to be secured to the backrest 3. The portion of the locking pin 12 intended to be received by the receiving member generally extends horizontally in a transverse direction.

A rotary latch 20 is pivotably supported on a first bearing pin 51. The rotary latch 20 has for this purpose a rotary latch hole 24 which is constructed in this case as a circular opening and through which the first bearing pin 51 extends. The rotary latch 20 further has for cooperation with the locking pin 12 a hooked aperture 21. By means of a first spring 71, the rotary latch 20 is pretensioned in the opening direction.

The rotary latch 20 has a functional face 22 which partially laterally delimits the hooked aperture 21. In the locked state, the functional face 22 is substantially directed in the direction of a second bearing pin 52 which is arranged parallel with the first bearing pin 51 and consequently also extends in the transverse direction. The functional face 22 is in this instance constructed in a planar manner, but may, for example, also be constructed to be curved in the manner of a circular arc and convex or concave.

At the side of the hooked aperture 21 facing away from the rotary latch hole 24, opposite the functional face 22, the hooked aperture 21 is laterally delimited by a protrusion of the rotary latch 20.

The rotary latch 20 has a base member which is delimited in an axial direction by a planar base face in each case. The width of the functional face 22 corresponds to the thickness of the base member of the rotary latch 20, that is to say, the extent of the base member in an axial direction.

The first bearing pin 51 is inserted into a first bearing hole 13 of the first side plate 16 and into a second bearing hole 14 of the second side plate 18 and protrudes from the base faces of the side plates 16, 18 in a perpendicular manner. The first bearing pin 51 consequently extends horizontally in a transverse direction. The second bearing pin 52 is also inserted into a first bearing hole 13 of the first side plate 16 and into a second bearing hole 14 of the second side plate 18 and protrudes perpendicularly from the base faces of the side plates 16, 18. The second bearing pin 52 consequently also extends horizontally in a transverse direction.

The locking unit 10 is in this instance secured, in this case screwed, to a lock connection sheet 60 which is part of the backrest 3. The lock connection sheet 60 is constructed in a substantially flat manner and extends in a plane perpendicular to the transverse direction. In this instance, the second side plate 18 of the locking unit 10 is in abutment with the lock connection sheet 60, whilst the first side plate 16 is located facing away from the lock connection sheet 60.

The first bearing pin 51 is constructed in a substantially hollow-cylindrical manner and has a through-opening 55 which extends in an axial direction and which has a substantially constant inner diameter.

In a first axial portion A1, the first bearing pin 51 has a first outer diameter D1. The first axial portion A1 extends, beginning at the lock connection sheet 60, away from it in an axial direction as far as the first side plate 16. In a central region of the first axial portion A1, the first bearing pin 51 in this instance has a flange-like expansion 81 whose outer diameter is greater than the first outer diameter D1.

The first axial portion A1 is inserted into a second bearing opening 14 of the second side plate 18 and is surrounded in this instance by the hollow cylinder 15. The end face of the hollow cylinder 15 opposite the lock connection sheet 60 is in abutment with the flange-like expansion 81 of the first axial portion A1. The first spring 71 is placed around the hollow cylinder 15.

At the side of the flange-like expansion 81 facing away from the hollow cylinder 15, the rotary latch 20 which is supported on the first axial portion A1 is in abutment, in this instance with little play in the axial direction.

In a second axial portion A2, the first bearing pin 51 has a second outer diameter D2. The second outer diameter D2 is in this instance smaller than the first outer diameter D1 of the first axial portion A1. The second axial portion A2 is in abutment with the first axial portion A1 and extends in the opposite direction, that is to say, away from the second side plate 18. It is also conceivable for the second outer diameter D2 to be of the same size as the first outer diameter D1.

The second axial portion A2 protrudes into a securing opening 61 of the lock connection sheet 60 provided for this purpose. The inner diameter of the securing opening 61 in this instance corresponds to the second outer diameter D2 of the second axial portion A2. In the present embodiment, the second axial portion A2 protrudes through the lock connection sheet 60. Therefore, the length of the second axial portion A2 is in this instance greater than the thickness of the lock connection sheet 60.

In a third axial portion A3 which adjoins the end of the first axial portion A1 facing away from the second axial portion A2, the first bearing pin 51 has a third outer diameter D3. The third outer diameter D3 is in this instance smaller than the first outer diameter D1 of the first axial portion A1. It is also conceivable for the third outer diameter D3 to be of the same size as the first outer diameter D1.

The third axial portion A3 protrudes into one of the bearing holes 13 of the first side plate 16. The inner diameter of this bearing hole 13 in this instance substantially corresponds to the third outer diameter D3 of the third axial portion A3. In the present embodiment, the third axial portion A3 protrudes through the first side plate 16. Therefore, the length of the third axial portion A3 is in this instance greater than the thickness of the first side plate 16.

The first axial portion A1 is consequently located in an axial direction, which in this instance corresponds to the transverse direction, centrally between the second axial portion A2 and the third axial portion A3. The inner diameters of the axial portions A1, A2 and A3 are in this instance identical.

The second axial portion A2 with the second outer diameter D2 and the third axial portion A3 with the third outer diameter D3 in each case form a step with respect to the first axial portion A1 with the first outer diameter D1.

A portion of the securing means which is constructed as a screw 65 protrudes through the first bearing pin 51 in an axial direction. In this instance, a head 66 of the screw 65 is in abutment with the first side plate 16 of the locking unit 10. A shaft 67 of the screw 65 engages through the first bearing pin 51 and the lock connection sheet 60.

At the side of the lock connection sheet 60 facing away from the locking unit 10, there is provided a nut which is not illustrated and which has an inner thread and in which a corresponding outer thread of the shaft 67 of the screw 65 is screwed.

The nut is in this instance welded to the side of the lock connection sheet 60 facing away from the locking unit 10. Alternatively, the lock connection sheet 60 may also have a plunged collar which extends away from the locking unit 10 and in which an inner thread is produced.

The second bearing pin 52 is in this case constructed so as to be identical to the first bearing pin 51 and a securing means which is constructed as a screw 65 also extends through it. This screw 65 is also screwed into a nut, which is arranged at the side of the lock connection sheet 60 facing away from the locking unit 10, or into an inner thread of a plunged collar.

The locking unit 10 is consequently connected to the lock connection sheet 60 by means of two screws 65. The screws 65 also protrude through the first bearing openings 13 in the first side plate 16, the hollow cylinders 15, the second bearing openings 14 in the second side plate 18 and the securing openings 61 in the lock connection sheet 60.

Alternatively, the securing means 65 of the first bearing pin 51 and the second bearing pin 52 may also be constructed as a rivet.

A clamping element 40 is pivotably supported on the second bearing pin 52. To this end, the clamping element 40 has an in this instance circular clamping element hole 44, through which the second bearing pin 52 extends. By means of a third spring 73, the clamping element 40 is pretensioned in the direction toward the rotary latch 20.

In the locked state, when the hooked aperture 21 of the rotary latch 20 receives the locking pin 12, the clamping element 40 applies as a result of the pretensioning by the third spring 73 as a securing element a closing torque to the rotary latch 20. To this end, the clamping element 40 has a clamping face 41 which is curved in an eccentric manner with respect to the second bearing pin 52 and which is located in non-self-locking contact with the functional face 22 of the rotary latch 20. The clamping face 41 is in this instance constructed to be curved in a circular manner and convex.

A catch detent 30 is arranged on the second bearing pin 52 axially beside the clamping element 40 and is also pivotably supported on the second bearing pin 52, that is to say, in alignment with the clamping element 40. To this end, the catch detent 30 has a catch detent hole 34 which is circular in this instance and through which the second bearing pin 52 extends. By means of a second spring 72, the catch detent 30 is pretensioned toward the rotary latch 20.

The catch detent 30 is in this instance arranged adjacent to the first side plate 16 and the clamping element 40 is in this instance arranged adjacent to the second side plate 18. The catch detent 30 and the clamping element 40 are coupled for entrainment with non-operative travel, for example, by means of a tongue and groove guide or by means of an axially protruding carrier.

The catch detent 30 has a catch face 31 which is located adjacent to the clamping face 41 of the clamping element 40. In the locked state, the catch face 31 is positioned with spacing from the functional face 22 of the rotary latch 20. The catch face 31 is in this instance constructed to be curved in the manner of a circular arc and convex, but may also be planar.

The width of the functional face 22, which corresponds to the thickness of the base member of the rotary latch 20, also substantially corresponds to the sum of the thickness of the catch detent 30 and the thickness of the clamping element 40. The rotary latch 20 thus has substantially the same material thickness as the catch detent 30 and the clamping element 40 together.

If, in the event of a crash, the rotary latch 20 is subjected to an opening torque and pushes the clamping element 40 away slightly, the catch face 31 moves into abutment with the functional face 22 of the rotary latch 20. The catch detent 30 thus serves to support the rotary latch 20 and prevents as an additional securing element a further rotation of the rotary latch 20 in the opening direction. Consequently, the catch detent 30 prevents opening of the rotary latch 20.

In the locked state of the locking unit 10, the locking pin 12 is located in the receiving member formed by the side plates 16, 18 and in the hooked aperture 21 of the closed rotary latch 20. The clamping element 40 secures the rotary latch 20 as a result of the cooperation of the clamping face 41 with the functional face 22. The catch face 31 of the catch detent 30 is slightly spaced apart from the functional face 22 of the rotary latch 20.

In order to open the locking unit 10, the catch detent 30 is pivoted away from the rotary latch 20, whereby the catch face 31 of the catch detent 30 moves further away from the functional face 22 of the rotary latch 20. The catch detent 30 also carries the clamping element 40 as a result of the carrying coupling arrangement so that the rotary latch 20 is no longer secured.

As a result of the pretensioning by means of the first spring 71, the rotary latch 20 opens and thus pivots in an opening direction. Alternatively or in addition to the pretensioning by the first spring 71, the rotary latch 20 can also be carried for opening by the catch detent 30 or by the clamping element 40.

As a result of the pivot movement of the rotary latch 20, the hooked aperture 21 is withdrawn from the receiving member formed by the side plates 16, 18 and releases the locking bolt 12, which moves away counter to the inward pivoting direction of the locking unit 10. If the locking bolt 12 has left the hooked aperture 21, the locking unit 10 is located in the unlocked state.

If, in this unlocked state, the locking pin 12 again reaches the receiving member formed by the side plates 16, 18 and moves into abutment with the edge of the hooked aperture 21, the locking pin 12 presses the rotary latch 20 into the closed position thereof. The clamping element 40 moves as a result of the pretensioning thereof by the third spring 73 along the functional face 22. In a state carried by the clamping element 40 or as a result of the pretensioning by the second spring 72, the catch detent 30 pivots toward the rotary latch 20, wherein the catch face 31 of the functional face 22 moves closer to the rotary latch 20. Afterwards, the locking unit 10 is located in the locked state again.

The features disclosed in the above description, the claims and the drawings may be significant both individually and in combination for the implementation of the invention in its various embodiments.

While specific embodiments of the invention have been shown and described in detail to illustrate the application of the principles of the invention, it will be understood that the invention may be embodied otherwise without departing from such principles.

1. A vehicle seat comprising:
a structural component which has a lock connection sheet defining a securing opening; and
a locking unit which is secured to the lock connection sheet, the locking unit comprising a securing element and at least one bearing pin having a through-opening through which the securing element protrudes, wherein the at least one bearing pin protrudes into the securing opening of the lock connection sheet.

2. The vehicle seat as claimed in claim 1, wherein the bearing pin has a first axial portion having a first outer diameter and a second axial portion having a second outer diameter, wherein the second outer diameter is smaller than the first outer diameter.

3. The vehicle seat as claimed in claim 2, wherein the second axial portion protrudes into the securing opening of the lock connection sheet.

4. The vehicle seat as claimed in claim 3, wherein the second outer diameter substantially corresponds to an inner diameter of the securing opening.

5. The vehicle seat as claimed in claim 2, wherein the bearing pin has a third axial portion having a third outer diameter which is smaller than the first outer diameter.

6. The vehicle seat as claimed in claim 5, wherein the first axial portion is arranged in an axial direction between the second axial portion and the third axial portion.

7. The vehicle seat as claimed in claim 5, wherein inner diameters of the axial portions (A1, A2, A3) are identical.

8. The vehicle seat as claimed in claim 5, wherein the third axial portion protrudes into a bearing hole in a side plate which faces away from the lock connection sheet.

9. The vehicle seat as claimed in claim 8, wherein a length of the third axial portion is greater than the thickness of the side plate which faces away from the lock connection sheet.

10. The vehicle seat as claimed in claim 2, wherein the locking unit further comprises a side plate in abutment with the lock connection sheet and which comprises at least one bearing hole in which the first axial portion is inserted.

11. The vehicle seat as claimed in claim 10, further comprising a hollow cylinder wherein the hollow cylinder is arranged around the bearing hole and the hollow cylinder extends in a direction away from the lock connection sheet and at least partially surrounds the first axial portion.

12. The vehicle seat as claimed in claim 11, wherein the first axial portion has in a central region a flange with an outer diameter that is greater than the first outer diameter, and the end face of the hollow cylinder facing away from the lock connection sheet is in abutment with the flange.

13. The vehicle seat as claimed in claim 11, further comprising a spring which pretensions a rotary latch wherein the spring is placed around the hollow cylinder.

14. The vehicle seat as claimed in claim 1, wherein the securing element comprises a screw which has a head and a shaft.

15. The vehicle seat as claimed in claim 14, wherein the shaft engages through the bearing pin and the lock connection sheet.
